(19) United States
(12) Patent Application Publication
(10) Pub. No.: US 2010/0312986 A1
(43) Pub. Date: Dec. 9, 2010

(54) SEMICONDUCTOR INTEGRATED CIRCUIT

(75) Inventor: Takashi Fujiwara, Tokyo (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/722,203

(22) Filed: Mar. 11, 2010

(30) Foreign Application Priority Data
Jun. 4, 2009 (JP) 2009-135390

(51) Int. Cl. G06F 12/00

(52) U.S. Cl. 711/216; 711/E12.001

(57) ABSTRACT

A semiconductor integrated circuit includes: a data path configured to transmit data from a first region to a second region; a first hash value calculator configured to read first data being transmitted through the data path within the first region and to calculate a first hash value from the first data; a register being disposed on the data path within the second region and configured to read second data transmitted through the data path; a second hash value calculator configured to read the second data output from the register and to calculate a second hash value from the second data; and a comparator configured to compare the first hash value and the second hash value and to determine whether the first hash value and the second hash value coincide with each other.

### RELATED APPLICATION(S)

The present disclosure relates to the subject matter contained in and claims priority to Japanese Patent Application No. 2009-135390 filed on Jun. 4, 2009, which is incorporated herein by reference in its entirety.

### FIELD

The present invention relates to a semiconductor integrated circuit capable to easily detect a defect.

### BACKGROUND

Recently, some semiconductor integrated circuits have a plurality of regions which operate at different frequencies or voltages (for example, see JP-A-2006-313893). In such a semiconductor integrated circuit, there is a case where, when data are transmitted between regions of different frequencies or voltages, a data transmission error in which the data are not correctly transmitted occurs. A semiconductor integrated circuit that causes such a data transmission error is a defective product, and, before shipment, a data transmission error must be detected.

In order to detect a data transmission error, a method of checking whether data are correctly transmitted between first and second regions or not is performed in the following manner. First, for example, data are written from a CPU disposed on the side of the first region, into a memory disposed on the side of the second region. Then, the data are read from the memory, and it is checked whether the written data coincide with the read data or not. If the written data coincide with the read data, it is confirmed that the data are correctly transmitted through write and read paths (data path) through which the CPU and the memory are connected to each other. In the method, however, a memory must be connected to the second region. In a case where the checking method is actually performed, sometimes, such a memory is not connected. For this reason, sometimes, the above-described checking method cannot be applied.

### SUMMARY

According to a first aspect of the invention, there is provided a semiconductor integrated circuit including: a first region configured to operate at a first voltage and a first frequency; a second region configured to be disposed adjacently to the first region and to operate at a second voltage and second frequency, at least one of which being different from the first voltage or the first frequency; a data path configured to transmit data from the first region to the second region; a first hash value calculator configured to read first data being transmitted through the data path within the first region and to calculate a first hash value from the first data; a register being disposed on the data path within the second region and configured to read second data transmitted through the data path; a second hash value calculator configured to read the second data output from the register and to calculate a second hash value from the second data; and a comparator configured to compare the first hash value and the second hash value and to determine whether the first hash value and the second hash value coincide with each other.

According to a second aspect of the invention, there is provided a semiconductor integrated circuit including: a first region configured to operate at a first voltage and a first frequency; a second region configured to be disposed adjacently to the first region and to operate at a second voltage and second frequency, at least one of which being different from the first voltage or the first frequency; a data path configured to transmit data from the first region to the second region; a register being disposed on the data path within the second region and configured to read data transmitted through the data path; a hash value calculator configured to read the data output from the register and to calculate a hash value from the data; and a comparator configured to compare the hash value and a pre-calculated expected value.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a diagram schematically showing the configuration of a semiconductor integrated circuit according to a first embodiment of the invention.

FIG. 2 is a block diagram of the semiconductor integrated circuit of the first embodiment of the invention.

FIG. 3 is a diagram of data which are transmitted through a data path of the semiconductor integrated circuit of the first embodiment of the invention.

FIG. 4 is a flowchart of detection of a data transmission error in the semiconductor integrated circuit of the first embodiment of the invention.

FIG. 5 is a block diagram of a semiconductor integrated circuit according to a second embodiment of the invention.

FIG. 6 is a block diagram of a semiconductor integrated circuit according to a third embodiment of the invention.

FIG. 7 is a diagram of data which are transmitted through a data path of the semiconductor integrated circuit of the third embodiment of the invention, and those which are stored in a start register and a stop register.

FIG. 8 is a flowchart of detection of a data transmission error in the semiconductor integrated circuit of the third embodiment of the invention.

FIG. 9 is a diagram of data which are transmitted through a data path of the semiconductor integrated circuit of the third embodiment of the invention.

FIG. 10 is a block diagram of a semiconductor integrated circuit according to a fourth embodiment of the invention.

FIG. 11 is a block diagram of a semiconductor integrated circuit according to a fifth embodiment of the invention.

### DETAILED DESCRIPTION OF THE EMBODIMENT(S)

Hereinafter, embodiments of the invention will be described with reference to the drawings. In the following description, common reference numerals are assigned to common components and elements throughout the drawings.

### First Embodiment

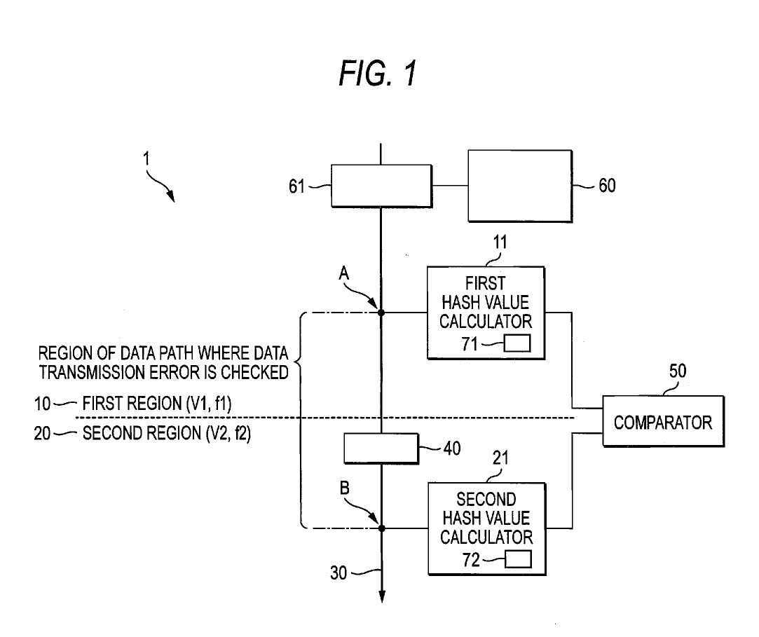

A semiconductor integrated circuit according to a first embodiment of the invention will be described with reference to FIG. 1. FIG. 1 is a diagram schematically showing the configuration of the semiconductor integrated circuit of the first embodiment. As shown in FIG. 1, the semiconductor integrated circuit 1 is configured to have a first region 10, a second region 20, a data path 30, a first hash value calculator 11, a second hash value calculator 21, a register 40, and a comparator 50. The semiconductor integrated circuit 1 may further have a pattern generator 60 and a multiplexer 61.

In the first region 10, electronic circuits and the like (not shown) which operate at a first voltage V1 and a first frequency f1 are disposed.

In the second region 20, electronic circuits and the like (not shown) which operate at a second voltage V2 and a second frequency f2 are disposed. In at least one of the sets of the first voltage V1 and the second voltage V2, and the first frequency f1 and the second frequency f2, the voltages or the frequencies are different from each other. Namely, the second voltage V2 and the second frequency f2 are assumed to be one of three combinations ((V1=V2, f1≠f2), (V1≠V2, f1=f2), and (V1≠V2, f1≠f2)).

The data path 30 through which data are transmitted from the first region 10 to the second region 20 is disposed between the first region 10 and the second region 20. Through the data path 30, data (hereinafter, referred to as “transmission data”) are transmitted from the first region 10 to the second region 20. As described later, the transmission data form a data stream configured by a plurality of data.

The register 40 is disposed in the data path 30 on the side of the second region 20, and reads transmission data which are transmitted through the data path 30. The register 40 sequentially reads transmission data which are transmitted from the side of the first region to the second region, and sequentially outputs the read transmission data to the data path 30.

The first hash value calculator 11 is connected through a node A to the data path 30 on the side of the first region 10 to read transmission data (first transmission data) which are transmitted through the data path 30, from the data path 30. From the first transmission data, the first hash value calculator 11 calculates a hash value (first hash value) inherent in the first transmission data, in accordance with a predetermined hash function. The calculated first hash value is retained in a hash value retaining unit 71. The address of the hash value retaining unit 71 is registered in a memory map.

The second hash value calculator 21 is connected through a node B to the data path 30 to read transmission data (second transmission data) which are output from the register 40 to the data path 30. From the second transmission data, the second hash value calculator 21 calculates a hash value (second hash value) inherent in the second transmission data, in accordance with a predetermined hash function. The calculated second hash value is retained in a hash value retaining unit 72. The address of the hash value retaining unit 72 is registered in the memory map.

It is assumed that the hash function used in the first hash value calculator 11 is substantially the same with that used in the second hash value calculator 21. In the case where the first transmission data are substantially the same with the second transmission data, thereby, the first hash value coincides with the second hash value. In the case where the first transmission data are not substantially the same with the second transmission data, the first hash value does not coincide with the second hash value.

The comparator 50 compares whether the first hash value calculated by the first hash value calculator 11 coincides with the second hash value calculated by the second hash value calculator 21 or not.

The pattern generator 60 generates transmission data which are to be transmitted through the data path 30. The transmission data generated by the pattern generator 60 can be arbitrarily set.

The multiplexer 61 receives transmission data which are transmitted from the upstream side of the data path 30, and those which are supplied from the pattern generator 60. Based on a selection signal which is not shown, the multiplexer selects the transmission data supplied from the upstream side of the data path 30, or those supplied from the pattern generator 60, and outputs the selected transmission data to the data path 30.

According to the configuration, it is possible to check a data transmission error in the case where data are transmitted from the first region to the second region through the data path 30. The first hash value which is calculated by the first hash value calculator 11 from the first transmission data that are read from the data path 30 on the side of the first region 10 through the node A is compared with the second hash value which is calculated by the second hash value calculator 21 from the second transmission data that are read from the data path 30 on the side of the second region 20 through the node B, whereby it is possible to check whether a data transmission error occurs in a range between the nodes A and B in the data path 30 or not. If the first hash value coincides with the second hash value, namely, this means that the first transmission data coincide with the second transmission data, and it is confirmed that a data transmission error does not occur in the range between the nodes A and B in the data path 30. On the other hand, if the first hash value does not coincide with the second hash value, this means that the first transmission data do not coincide with the second transmission data, and it is confirmed that a data transmission error occurs in the range between the nodes A and B in the data path 30.

Since the address of the hash value retaining unit 71 which retains the first hash value calculated by the first hash value calculator 11, and that of the hash value retaining unit 72 which retains the second hash value calculated by the second hash value calculator 21 are registered in the memory map, a CPU (Central Processing Unit) which is not shown can read the first and second hash values retained in the hash value retaining units 71, 72. Thereby, the CPU can compare the first and second hash values with each other without using the comparator 50.

The pattern generator 60 and the multiplexer 61 cooperate to transmit the transmission data generated by pattern generator 60 through the data path 30. Even when a configuration for generating transmission data is not connected to the upstream of the data path 30 on the side of the first region, thereby, it is possible to check a data transmission error in the range between the nodes A and B in the data path 30.

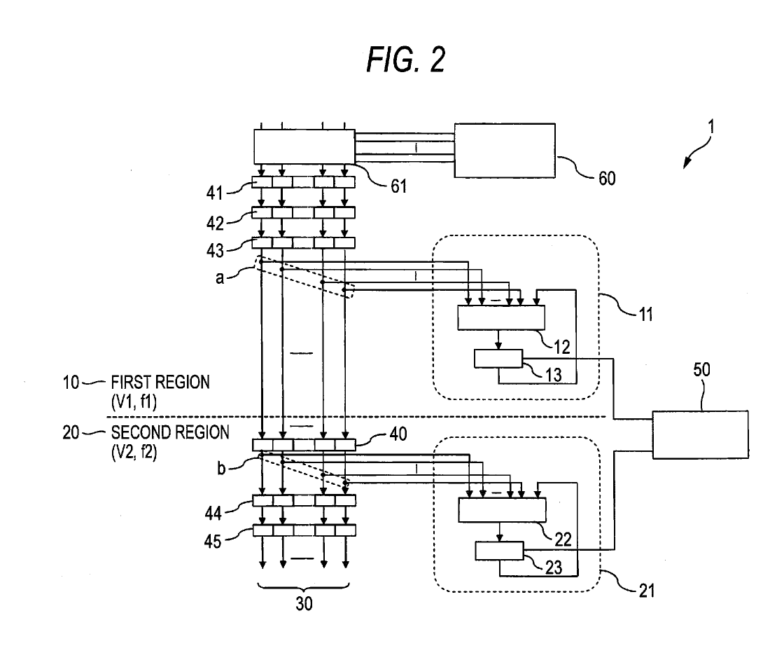

With reference to FIG. 2, next, the semiconductor integrated circuit of first embodiment will be described in more detail. FIG. 2 is a block diagram of the semiconductor integrated circuit 1 of first embodiment of the invention. The components which are similar to those of FIG. 1 are denoted by the same reference numerals. The data path 30 is a transmission line through which transmission data are transmitted in parallel. The data width of transmission data to be transmitted through the data path 30 is 8 bits. In order to facilitate understanding of the description, the example in which the data path 30 is a parallel transmission line, and the data width of transmission data is 8 bits will be described. Alternatively, the data path 30 may be a serial transmission line, and transmission data may have a data width other than 8 bits.

In the data path 30 on the side of the first region 10, registers 41, 42, 43 which read transmission data and sequentially output the read transmission data are connected in multiple stages, thereby configuring a transmission line of the FIFO (First-In First-Out) type. Each of the registers 41, 42, 43 is configured by, for example, flip-flop circuits in accordance with the data width of the transmission data. In the embodiment, each of the registers 41, 42, 43 is configured by eight flip-flop circuits.

In the data path 30 on the side of the second region 20, registers 40, 44, 45 which read transmission data and read transmission data are connected in multiple stages, thereby configuring a transmission line of the FIFO type. The registers 40, 44, 45 are configured in the same manner as the registers 41, 42, 43. The register 40 shown in FIG. 2 corresponds to the register 40 shown in FIG. 1.

The registers 41, 42, 43 and the registers 40, 44, 45 are storage devices which hold data, and, when a fetch signal to the FIFO is in the enable state, hold data which are sent from the previous stage.

The first hash value calculator 11 calculates a hash value by the exclusive OR calculation. The first hash value calculator 11 is configured to have an XOR calculator which performs the exclusive OR calculation, and a flip-flop unit 13. The method of calculating a hash value is a known technique, and hence a detailed description thereof is omitted in the embodiment. In the embodiment, as an example, a configuration and method in which a hash value is calculated by the exclusive OR calculation will be described. However, the method is not restricted to the exclusive OR calculation.

The XOR calculator 12 receives transmission data transmitted through the data path 30, and the output of the flip-flop unit 13. The XOR calculator 12 performs the exclusive OR calculation of the transmission data from the data path 30, and the output of the flip-flop unit 13, and outputs a result of the calculation to the flip-flop unit 13.

The flip-flop unit 13 fetches the calculation result from the XOR calculator 12, and outputs the fetched calculation result to the XOR calculator 12. The calculation result which is fetched from the XOR calculator 12 by the flip-flop unit 13 can be read by the comparator 50. The value which is output from the flip-flop unit 13 to the XOR calculator 12 can be set from the outside. In the example shown in FIG. 2, the flip-flop unit 13 corresponds to the hash value retaining unit 71 in FIG. 1.

The configuration of the second hash value calculator 21 is substantially the same with that of the first hash value calculator 11, and hence its description is omitted. In the example shown in FIG. 2, a flip-flop unit 23 corresponds to the hash value retaining unit 72 in FIG. 1.

The comparator 50 reads the first hash value from the flip-flop unit 13, and the second hash value from the flip-flop unit 23, and compares whether the first hash value and the second hash value coincide with each other or not.

The pattern generator 60 and the multiplexer 61 are configured in the same manner as shown in FIG. 1, and hence their description is omitted.

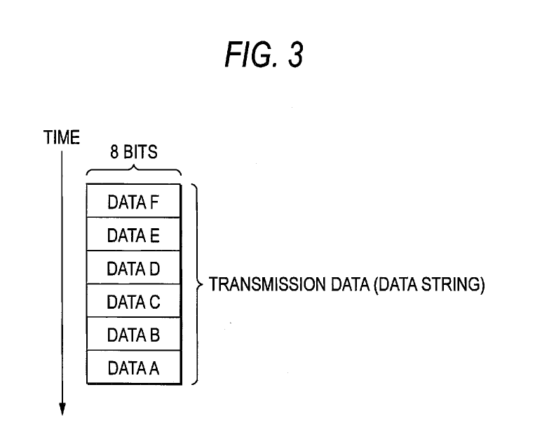

Next, the operation of calculating the hash value in the first hash value calculator 11 will be described with reference to FIGS. 2 and 3. FIG. 3 is a diagram of the transmission data which are transmitted through the data path 30. As shown in FIG. 3, the transmission data form a data stream configured by data A, B, C, D, E, and F which are to be sequentially transmitted. The data widths of data A, B, C, D, E, and F are 8 bits.

The data which are sequentially fetched from the data path by the first hash value calculator 11 are supplied to the XOR calculator 12. The XOR calculator 12 performs the exclusive OR calculation of data A which is initially input, and an initial value Z which is set in the flip-flop unit 13, and outputs a calculation result ÂZ to the flip-flop unit 13. The procedure of setting the initial value in the flip-flop unit 13 will be described later. Next, the XOR calculator 12 performs the exclusive OR calculation of data B which is then input, and the value ÂZ supplied from the flip-flop unit 13, and outputs a calculation result ÂẐB to the flip-flop unit 13. By repeating similar calculations, the first hash value calculator 11 performs the exclusive OR calculation of the data supplied from the data path 30, and finally outputs a calculation result to the flip-flop unit 13. The calculation result which is finally calculated by the first hash value calculator 11 is the first hash value.

The operation of calculating the hash value in the second hash value calculator 21 is performed in a similar manner as the first hash value calculator 11, and hence its description is omitted.

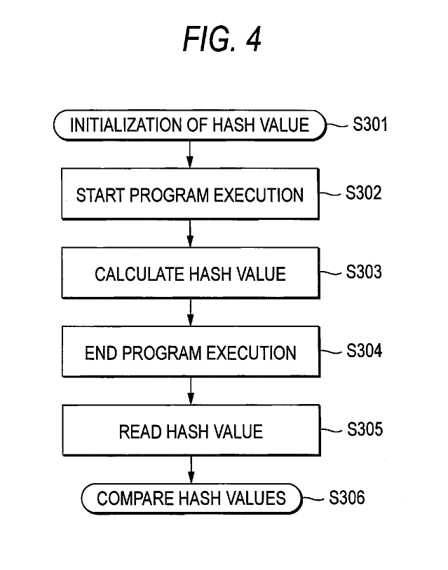

Next, the procedure of checking a data transmission error in the semiconductor integrated circuit 1 of the embodiment will be described with reference to FIG. 4. FIG. 4 is a flowchart of checking of a data transmission error in the semiconductor integrated circuit 1.

First, the same initial values Z are set in the flip-flop unit 13 of the first hash value calculator 11, and the flip-flop unit 23 of the second hash value calculator 21, respectively (S301).

Next, the program execution is started in the semiconductor integrated circuit 1 to transmit transmission data through the data path 30 (S302).

Next, the first hash value calculator 11 and the second hash value calculator 21 read data from the data path 30, and start the above-described operation to calculate a hash value (S303).

Then, the semiconductor integrated circuit 1 ends the program execution (S304). Thereby, data are not transmitted through the data path 30, and the first hash value calculator 11 and the second hash value calculator 21 end the calculations of the first and second hash values, and output the calculated first and second hash values to the flip-flop units 13, 23, respectively.

Next, the comparator 50 reads the first and second hash values from the flip-flop units 13, 23, respectively (S305), and compares whether the first and second hash values coincide with each other or not (S306). If the first and second hash values coincide with each other, it is confirmed that, in the semiconductor integrated circuit which is the object of the check, a data transmission error is not caused by the transmission data which are transmitted by the executed program. If the first and second hash values do not coincide with each other, it is confirmed that, in the semiconductor integrated circuit which is the object of the check, a data transmission error is caused by the transmission data which are transmitted by the executed program.

### Second Embodiment

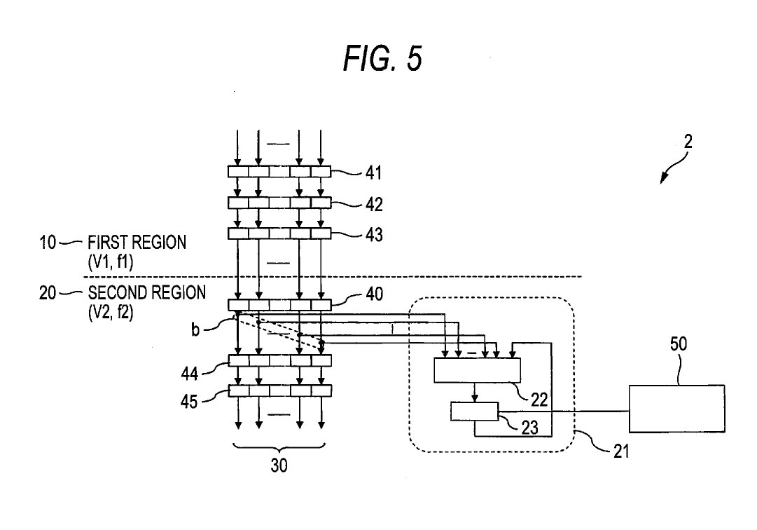

A semiconductor integrated circuit according to a second embodiment of the present invention will be described with reference to FIG. 5. FIG. 5 is a block diagram of the semiconductor integrated circuit 2 of second embodiment of the invention. The components which are configured in similar manner as those of FIGS. 1 and 2 are denoted by the same reference numerals, and their description is omitted.

The semiconductor integrated circuit 2 of the second embodiment is different from the semiconductor integrated circuit 1 of the first embodiment in that the semiconductor integrated circuit 2 of the second embodiment does not include the first hash value calculator 11 in the first embodiment.

In the second embodiment, in a normal semiconductor integrated circuit (a semiconductor integrated circuit in which a data transmission error is not caused) having the configuration shown in FIG. 2, predetermined transmission data are transmitted through the data path 30, and a hash value is calculated by the second hash value calculator 21. The calculated hash value is set as an expected value.

In the semiconductor integrated circuit which has the configuration shown in FIG. 2, and which is the object of the data transmission error check, next, predetermined transmission data (transmission data which are substantially the same with “predetermined transmission data” that are used for obtaining the expected value in a semiconductor integrated circuit in which a data transmission error is not caused) are transmitted through the data path 30, and the second hash value is calculated by the second hash value calculator 21.

Next, the expected value is compared with the second hash value, whereby it is possible to check whether, in the semiconductor integrated circuit which is the object of the data transmission error check, a data transmission error occurs in a range between an output source (not shown) of the transmission data in the data path 30 and the node B in the data path 30 or not. If the second hash value coincides with the expected value, namely, it is confirmed that a data transmission error does not occur in the range between the output source (not shown) of the transmission data in the data path 30 and the node B. On the other hand, if the second hash value does not coincide with the expected value, it is confirmed that a data transmission error occurs in the range between the output source (not shown) of the transmission data in the data path 30 and the node B.

As described above, according to the embodiment, the same effects as those of first embodiment can be achieved, and the circuit configuration can be more simplified than that of first embodiment, so that the low production cost and the space saving property can be further improved.

In the same manner as the semiconductor integrated circuit 1 of first embodiment, the semiconductor integrated circuit 2 of second embodiment may further have the pattern generator 60 and the multiplexer 61. When transmission data generated by the pattern generator 60 are supplied to the data path 30 and the above-described checking operation is performed, the distance between the output source (the pattern generator 60) of the transmission data and the node B is reduced, and, in the case where a data transmission error occurs, it is easy to identify the place where the data transmission error is caused.

### Third Embodiment

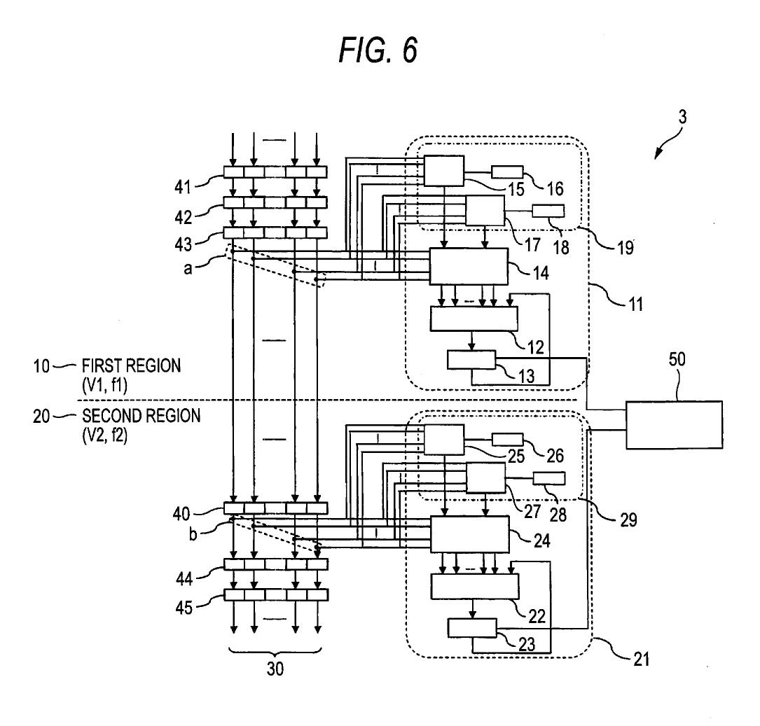

A semiconductor integrated circuit according to a third embodiment of the present invention will be described with reference to FIG. 6. FIG. 6 is a block diagram of the semiconductor integrated circuit 3 according to the third embodiment of the present invention. The components which are configured in a similar manner as those of FIGS. 1 and 2 are denoted by the same reference numerals, and their description will be omitted in below.

As described for the first and the second embodiments, transmission data which are to be transmitted through the data path 30 form a data stream configured by a plurality of data. In the case where, in the data stream, a portion where a data transmission error easily occurs is previously known, when the operation of detecting a data transmission error is performed on the portion, the checking time can be shortened. In the third embodiment, in order to enable the reduction of the checking time, controllers 19, 29 are used in the semiconductor integrated circuit 1 of the first embodiment.

The controller 19 controls timings of starting and ending the hash value calculation of the second hash value calculator 11. The controller 19 is configured to have a multiplexer 14, comparators 15, 17, a start register 16, and a stop register 18.

The controller 29 controls timings of starting and ending the hash value calculation of the first hash value calculator 21. The controller 29 is configured to have a multiplexer 24, comparators 25, 27, a start register 26, and a stop register 28.

The multiplexer 14 receives: transmission data transmitted through the data path 30; a signal (start signal) from the comparator 15; and a signal (stop signal) from the comparator 17. The output of the multiplexer 14 is coupled to the XOR calculator 12. When receiving the start signal from the comparator 15, the multiplexer 14 supplies the transmission data supplied through the data path 30, to the XOR calculator 12. When receiving that stop signal from the comparator 17, the multiplexer 14 stops the supply of the transmission data supplied through the data path 30, to the XOR calculator 12, and supplies value “0” to the XOR calculator 12.

The comparator 15 receives the transmission data transmitted through the data path 30. The start register 16 is connected to the comparator 15. The comparator 15 compares the transmission data transmitted through the data path 30 with data (start data) stored in the start register 16, and, if the both data coincide with each other, supplies the start signal to the multiplexer 14.

The comparator 17 receives the transmission data transmitted through the data path 30. The stop register 18 is connected to the comparator 17. The comparator 17 compares the transmission data transmitted through the data path 30 with data (stop data) stored in the stop register 18, and, if the both data coincide with each other, supplies the stop signal to the multiplexer 14.

The controller 29 is configured in the same manner as the controller 19, and hence its description is omitted. Specifically, the multiplexer 24 is substantially the same with the multiplexer 14, the comparators 25, 27 are substantially the same with the comparators 15, 17, respectively, the start register 26 is substantially the same with the start register 16, and the stop register 28 is substantially the same with the stop register 18.

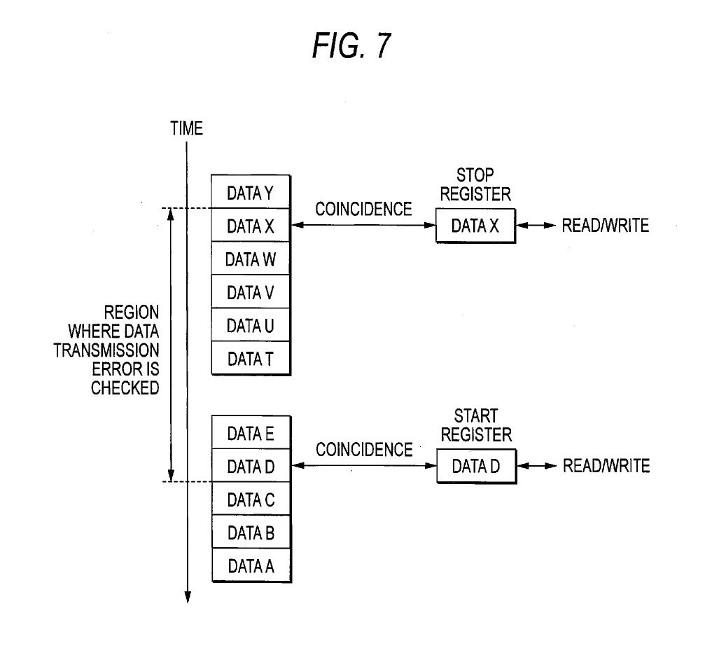

Next, the method of calculating a hash value by the first hash value calculator 11 will be described with reference to FIGS. 6 and 7. FIG. 7 is a diagram of the transmission data which are transmitted through the data path 30 of the semiconductor integrated circuit 3 of third embodiment of the invention, and the data (start data, stop data) stored in the start and stop registers. As shown in FIG. 7, the transmission data form a data stream configured by data A to Y which are to be sequentially transmitted.

In a state where the data stream (transmission data) shown in FIG. 7 are transmitted through the data path 30, the multiplexer 14 supplies the value “0” to the XOR calculator 12. When receiving the value “0” from the multiplexer 14, the XOR calculator 12 performs the exclusive OR calculation of the value “0” and the value Z which is set as the initial value in the flip-flop unit 13, and outputs the value Z which is the result of the calculation, to the flip-flop unit 13. At this time, thereby, the flip-flop unit 13 retains the value Z which is set as the initial value.

When data which are substantially the same with the start data D that are retained in the start register 16 are transmitted through the data path 30, next, the comparator 15 which reads the data D outputs the start signal to the multiplexer 14. Thereby, the transmission data which are transmitted through the data path 30 are supplied to the XOR calculator 12, and the first hash value calculator 11 (the XOR calculator 12) starts the calculation of a hash value.

When data which are substantially the same with the stop data X that are retained in the stop register 18 are transmitted through the data path 30, next, the comparator 15 which reads the data X outputs the stop signal to the multiplexer 14. Thereby, the transmission data which are transmitted through the data path output the value “0” to the XOR calculator 12, and hence the XOR calculator 12 performs the exclusive OR calculation with respect to the value retained by the flip-flop unit 13. As a result, the flip-flop unit 13 retains the hash value which is calculated by using the transmission data that are immediately before the input of the stop signal to the multiplexer.

By the above-described operation, the first hash value calculator 11 calculates the hash value with respect to the data stream in the range between the start data set in the start register 16 and the stop data set in the stop register 18, in the transmission data which are transmitted through the data path 30.

The method of calculating a hash value by the second hash value calculator 21 is substantially the same with that of calculating a hash value by the first hash value calculator 11, and thereby its description is omitted.

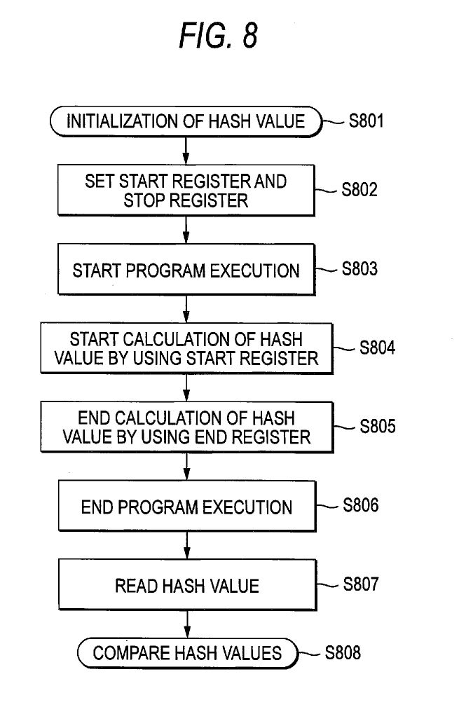

Next, the procedure of detecting a data transmission error in the semiconductor integrated circuit 3 of the embodiment will be described with reference to FIG. 8. FIG. 8 is a flowchart of checking of a data transmission error in the semiconductor integrated circuit.

First, the same initial values Z are set in the flip-flop unit 13 of the first hash value calculator 11, and the flip-flop unit 23 of the second hash value calculator 21, respectively (S801).

Next, the start data are set in the start registers 16, 26, and the stop data are set in the stop registers 18, 28 (S802).

Next, the program execution is started in the semiconductor integrated circuit to transmit transmission data through the data path 30 (S803).

Next, the first hash value calculator 11 and the second hash value calculator 21 start the calculation of a hash value by using the same data as those of the start registers as described above (S804).

Next, the first hash value calculator 11 and the second hash value calculator 21 end the calculation of a hash value by using the same data as those of the stop registers as described above (S805).

Next, the semiconductor integrated circuit ends the program execution (S806).

Then, the comparator 50 reads the first and second hash values from the flip-flop units 13, 23, respectively (S807), and compares whether the first and second hash values coincide with each other or not (S808). If the first and second hash values coincide with each other, it is confirmed that, in the boundary between the first and second regions, a data transmission error is not caused by the transmission data which are transmitted by the executed program. If the first and second hash values do not coincide with each other, it is confirmed that, in the boundary between the first and second regions, a data transmission error is caused by the transmission data which are transmitted by the executed program.

According to the configuration, when a check of a data transmission error is to be performed on a specific data stream (from the data D to the data X) in the transmission data which are transmitted through the data path 30, it is possible to designate start and stop data of the data stream. Thereby, the time for checking the transmission data can be shortened.

Modification

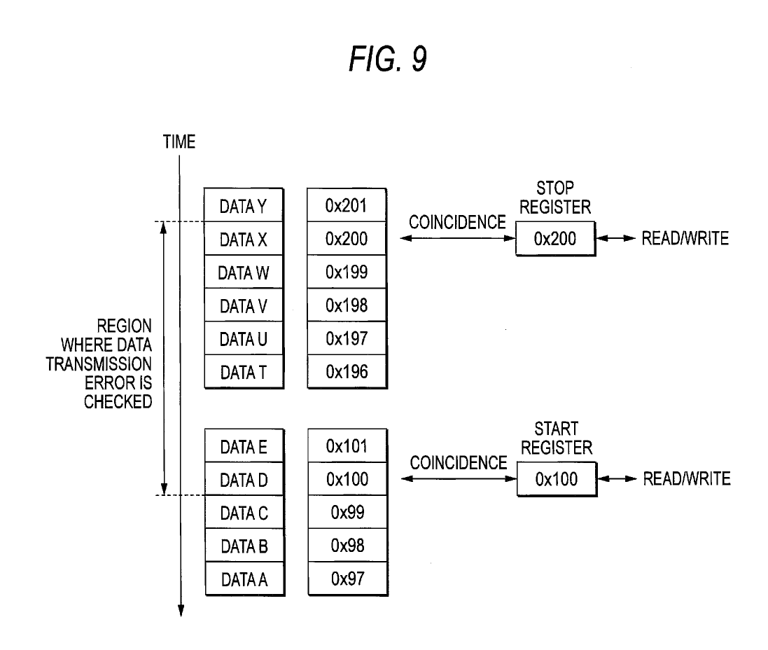

A semiconductor integrated circuit according to a modification of the third embodiment of the present invention will be described with reference to FIG. 9. FIG. 9 is a diagram of the semiconductor integrated circuit according to the modification of the third embodiment.

A method of operating the semiconductor integrated circuit according to the modification is different from that of operating the semiconductor integrated circuit according to the third embodiment, in that, in the semiconductor integrated circuit according to the modification, a counter is used in the method of designating the start and stop data of a data stream when a check of a data transmission error is to be performed on a specific data stream (from the data D to the data X).

In the semiconductor integrated circuit according to the modification, as shown in FIG. 9, the counter operates each time when data constituting transmission data are sequentially transmitted. A counter value corresponding to the start data of the specific data stream on which the checking of a data transmission error is performed is previously set as a start counter value into the start register, and that corresponding to the stop data is set as a stop counter value into the stop register. In the same manner as third embodiment, then, the transmission data are transmitted through the data path 30, and the first hash value calculator 11 and the second hash value calculator 21 start the calculation of a hash value while the data of the transmission data designated by the start counter value is used as the start data, and end the calculation of a hash value while the data of the transmission data designated by the stop counter value is used as the stop data. Thereby, the first hash value calculator 11 and the second hash value calculator 21 calculate the first hash value and the second hash value, respectively, and the first hash value and the second hash value are compared with each other, so that it is possible to check whether a data transmission error occurs or not, by the transmission of the data stream (from the data D to the data X) through the data path 30.

### Fourth Embodiment

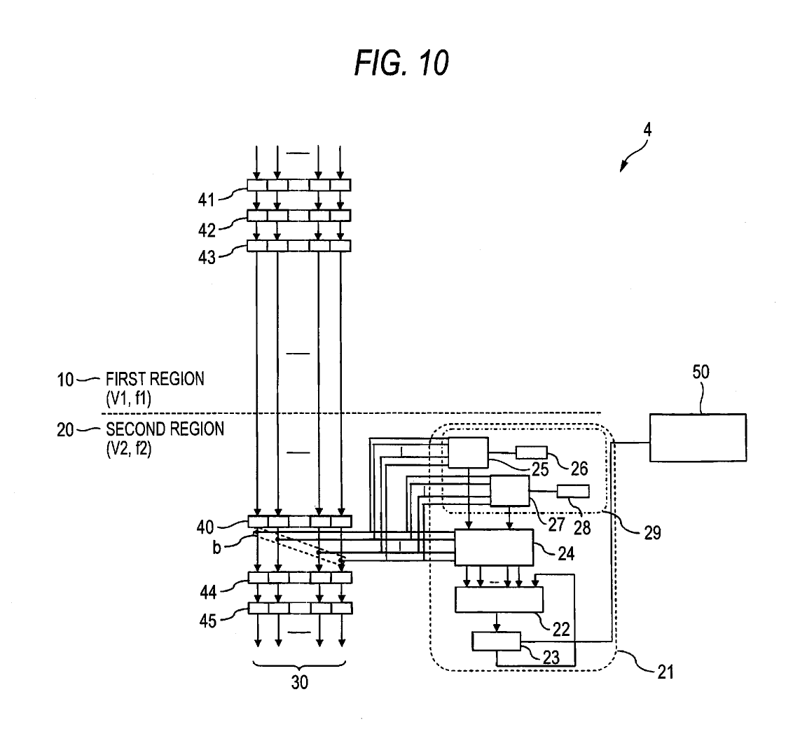

A semiconductor integrated circuit according to a fourth embodiment of the present invention will be described with reference to FIG. 10. FIG. 10 is a block diagram of the semiconductor integrated circuit 4 according to the fourth embodiment of the present invention. The components which are configured in a similar manner as those of FIG. 6 are denoted by the same reference numerals, and their description is omitted.

The semiconductor integrated circuit 4 according to the embodiment is different from the semiconductor integrated circuit according to the third embodiment in that the semiconductor integrated circuit 4 according to the fourth embodiment is not provided with the first hash value calculator 11 of the third embodiment.

In the fourth embodiment, in the same manner as the second embodiment, predetermined transmission data are transmitted through the data path 30 in a normal semiconductor integrated circuit (a semiconductor integrated circuit in which a data transmission error is not caused), a hash value is calculated by the second hash value calculator 21, and a data transmission error can be checked while using the calculated hash value as an expected value.

In the embodiment, in the same manner as the third embodiment, the start register 26 and the stop register 28 are used, thereby enabling a check of a data transmission error on a specific data stream to be performed.

### Fifth Embodiment

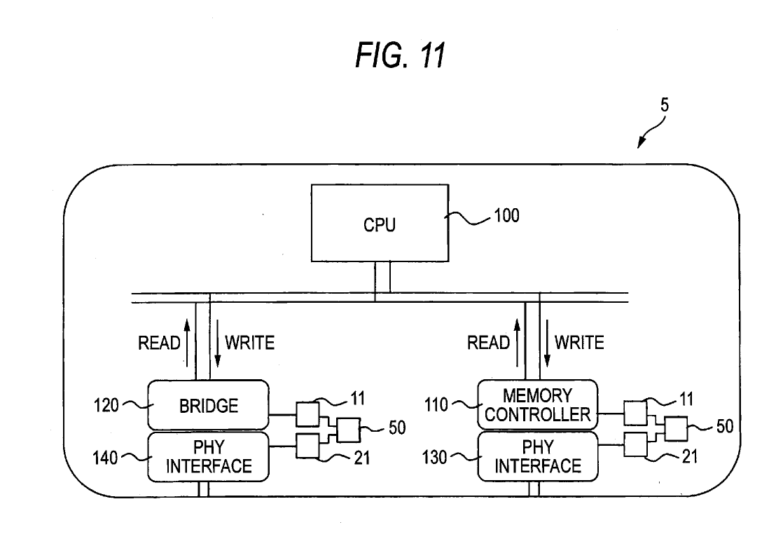

A semiconductor integrated circuit according to a fifth embodiment of the present invention will be described with reference to FIG. 11. FIG. 11 is a block diagram of the semiconductor integrated circuit 5 according to the fifth embodiment of the present invention.

The semiconductor integrated circuit 5 according to the fifth embodiment is an example of a semiconductor integrated circuit in which any one of the configurations of the first to the fourth embodiments is implemented.

As shown in FIG. 11, the semiconductor integrated circuit according to the fifth embodiment includes a CPU (Central Processing Unit) 100, a memory controller 110, abridge circuit 120, and PHY interfaces 130, 140. The PHY interface 130 serves to, for example, convert a logic signal to an electric signal between the memory controller 110 and a memory (not shown) that is connected to an external device. The PHY interface 140 serves to, for example, convert a logic signal to an electric signal between the bridge circuit 120 and an external circuit (not shown) that is connected to an external device. The bridge circuit 120 serves to perform protocol conversion between the bridge circuit 120 and a CPU bus (a data line connecting the CPU 100 with the bridge circuit 120).

Generally, a voltage or a frequency is different between the memory controller 110 and the PHY interface 130, and between the bridge circuit 120 and the PHY interface 140. When data are transmitted between them, thereby, there is a high possibility that a data transmission error occurs. In the embodiment, thereby, a data transmission line between the memory controller 110 and the PHY interface 130, and that between the bridge circuit 120 and the PHY interface 140 have one of the configurations of the first to the fourth embodiments, whereby it is possible to check a data transmission error in the data transmission lines between the memory controller 110 and the PHY interface 130, and between the bridge circuit 120 and the PHY interface 140.

Although the embodiment in which the memory controller 110 and the PHY interface 130, and the bridge circuit 120 and the PHY interface 140 are used has been described, the present invention is not limited to this configuration.

It is to be understood that the present invention is not limited to the specific embodiments described above and that the present invention can be embodied with the components modified without departing from the spirit and scope of the present invention. The present invention can be embodied in various forms according to appropriate combinations of the components disclosed in the embodiments described above. For example, some components may be deleted from the configurations as described as the embodiments. Further, the components in different embodiments may be used appropriately in combination.

What is claimed is:

1. A semiconductor integrated circuit comprising:
a first region configured to operate at a first voltage and a first frequency;
a second region configured to be disposed adjacently to the first region and to operate at a second voltage and second frequency, at least one of which being different from the first voltage or the first frequency;
a data path configured to transmit data from the first region to the second region;
a first hash value calculator configured to read first data being transmitted through the data path within the first region and to calculate a first hash value from the first data;
a register being disposed on the data path within the second region and configured to read second data transmitted through the data path;
a second hash value calculator configured to read the second data output from the register and to calculate a second hash value from the second data; and
a comparator configured to compare the first hash value and the second hash value and to determine whether the first hash value and the second hash value coincide with each other.

2. The semiconductor integrated circuit of claim 1 further comprising:
a first register configured to retain a first reference value to which the first hash value calculator refers;
a second register configured to retain a second reference value to which the first hash value calculator refers;
a third register configured to retain a third reference value to which the second hash value calculator refers; and
a fourth register configured to retain a fourth reference value to which the second hash value calculator refers,
wherein the first hash value calculator is configured to start calculating the first hash value when the first data coincides with the first reference value and to end calculating the first hash value when the first data coincides with the second reference value, and
wherein the second hash value calculator is configured to start calculating the second hash value when the second data coincides with the third reference and to end calculating the second hash value when the second data coincides with the fourth reference value.

3. The semiconductor integrated circuit of claim 1, wherein the first hash value calculator comprises a first memory configured to retain the first hash value, the first memory having a first address being registered in a memory map, and
wherein the second hash value calculator comprises a second memory configured to retain the second has value, the second memory having a second address being registered in the memory map.

4. The semiconductor integrated circuit of claim 1, wherein one of the first region and the second region comprises a PHY interface.

5. The semiconductor integrated circuit of claim 1, wherein one of the first region and the second region comprises a PHY interface and the other of the first region and the second region comprises a memory controller.

6. The semiconductor integrated circuit of claim 1, wherein one of the first region and the second region comprises a PHY interface and the other of the first region and the second region comprises a bridge circuit.

7. A semiconductor integrated circuit comprising:
a first region configured to operate at a first voltage and a first frequency;
a second region configured to be disposed adjacently to the first region and to operate at a second voltage and second frequency, at least one of which being different from the first voltage or the first frequency;
a data path configured to transmit data from the first region to the second region;
a register being disposed on the data path within the second region and configured to read data transmitted through the data path;
a hash value calculator configured to read the data output from the register and to calculate a hash value from the data; and
a comparator configured to compare the hash value and a pre-calculated expected value and to determine whether the hash value and the expected value coincide with each other.

8. The semiconductor integrated circuit of claim 7 further comprising:
a first register configured to retain a first reference value to which the hash value calculator refers; and
a second register configured to retain a second reference value to which the hash value calculator refers,
wherein the hash value calculator is configured to start calculating the hash value when the data coincides with the first reference value and to end calculating the hash value when the data coincided with the second reference value.

9. The semiconductor integrated circuit of claim 7, wherein the hash value calculator comprises a memory configured to retain the hash value, the memory having a address being registered in a memory map.

10. The semiconductor integrated circuit of claim 7, wherein one of the first region and the second region comprises a PHY interface.

11. The semiconductor integrated circuit of claim 7, wherein one of the first region and the second region comprises a PHY interface and the other of the first region and the second region comprises a memory controller.

12. The semiconductor integrated circuit of claim 7, wherein one of the first region and the second region comprises a PHY interface and the other of the first region and the second region comprises a bridge circuit.
